(19) United States
(12) Patent Application Publication
(10) Pub. No.: US 2023/0024163 A1
(43) Pub. Date: Jan. 26, 2023

(54) CONNECTOR ASSEMBLY

(71) Applicant: Tyco Electronics AMP Korea Co., Ltd., Gyeongsan (KR)

(72) Inventors: Jae Yong Bae, Gyeongsan-Si (KR); Kyu-Taek Jung, Gyeongsan-Si (KR)

(73) Assignee: Tyco Electronics AMP Korea Co., Ltd., Gyeongsan (KR)

(21) Appl. No.: 17/869,476

(22) Filed: Jul. 20, 2022

(30) Foreign Application Priority Data
Jul. 22, 2021 (KR) 10-2021-0096521
Jun. 16, 2022 (KR) 10-2022-0073536

(51) Int. Cl. H01R 13/629

(52) U.S. Cl. CPC H01R 13/62955; H01R 13/62938

(57) ABSTRACT

A connector assembly includes a base connector having a locking protrusion formed on an outer circumferential surface, a body connector capable of being inserted into the base connector, a main lever configured to be rotatably coupled to the body connector, a locking lever formed on the main lever and capable of engaging with the locking protrusion, and a position assurance slider disposed to engage with the locking lever to be slidable with respect to the locking lever and capable of preventing separation of the locking lever engaged with the locking protrusion.

### CROSS-REFERENCE TO RELATED APPLICATIONS

This application claims the benefit of Korean Patent Application No. 10-2021-0096521 filed on Jul. 22, 2021, and Korean Patent Application No. 10-2022-0073536 filed on Jun. 16, 2022, the Korean Intellectual Property Office, the entire disclosure of which are incorporated herein by reference for all purposes.

### FIELD OF THE INVENTION

The invention is related to electrical connectors and more particularly to a connector assembly.

### BACKGROUND

A connector is a kind of electrical component capable of connecting or disconnecting an electrical connection. The connector is used in various electromechanical devices such as automobiles or household appliances, and is used for electrical and/or physical connection between a plurality of electronic components.

In a connector to which a rotation lever is mounted, techniques for preventing damage to a connector position assurance member (CPA) are required. In addition, there is a need for techniques capable of more easily releasing the bound CPA.

### SUMMARY

Example embodiments provide a connector assembly capable of reducing damage to the CPA (e.g., a position assurance slider to be described later).

A connector assembly includes a base connector having a locking protrusion formed on an outer circumferential surface, a body connector capable of being inserted into the base connector, a main lever configured to be rotatably coupled to the body connector, a locking lever formed on the main lever and capable of engaging with the locking protrusion, and a position assurance slider disposed to engage with the locking lever to be slidable with respect to the locking lever and capable of preventing separation of the locking lever engaged with the locking protrusion.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a perspective view illustrating a connector assembly according to an example embodiment;

FIG. 2 is a perspective view illustrating a locking lever of a connector assembly according to an example embodiment;

FIG. 3 is a diagram illustrating an arrangement state of a main lever, a locking lever, and a housing of a connector assembly according to an example embodiment;

FIG. 4 is a perspective view illustrating a position assurance slider of a connector assembly according to an example embodiment;

FIG. 5 is a front view of a connector assembly according to an example embodiment and illustrates an arrangement state of a housing, a locking lever, and a position assurance slider;

FIG. 6 is a cut-away perspective view illustrating a housing of a connector assembly according to an example embodiment;

FIG. 7A to FIG. 7D are cross-sectional views of a connector assembly according to an example embodiment, and illustrate a binding process of a locking lever and a position assurance slider;

FIG. 8 is a cross-sectional view of a connector assembly according to an example embodiment; and

FIG. 9 is a cross-sectional view of a connector assembly according to an example embodiment.

### DETAILED DESCRIPTION

Hereinafter, example embodiments will be described in detail with reference to the accompanying drawings. The following description is one of several aspects of the example embodiments, and the following description composes of a part of the detailed description of the example embodiments. In describing an example embodiment, a detailed description of a well-known function or component will be omitted in order to clarify the gist of the present disclosure.

Various modifications may be made to the example embodiments. Here, the example embodiments are not construed as limited to the disclosure and should be understood to include all changes, equivalents, and replacements within the idea and the technical scope of the disclosure.

In addition, the terms or words used in the present specification and claims should not be construed in a conventional or dictionary meaning, and should be construed as meaning and concept consistent with the technical idea of the invention according to an example embodiment on the principle that the inventor can adequately define the concept of the term to best describe his or her invention.

As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, components or a combination thereof, but do not preclude the presence or addition of one or more other features, integers, steps, operations, elements, components, and/or groups thereof.

Unless otherwise defined herein, all terms used herein including technical or scientific terms have the same meanings as those generally understood by one of ordinary skill in the art. Terms defined in dictionaries generally used should be construed to have meanings matching contextual meanings in the related art and are not to be construed as an ideal or excessively formal meaning unless otherwise defined herein.

When describing the example embodiments with reference to the accompanying drawings, like reference numerals refer to like components and a repeated description related thereto will be omitted. In describing example embodiments, when it is determined that a specific description of a related known art may unnecessarily obscure the subject matter of the example embodiments, a detailed description thereof will be omitted.

In addition, although terms of “first,” “second,” “A,” “B,” “(a),” “(b),” and the like may be used to explain various components, the components are not limited to such terms. These terms are used only to distinguish one component from another component, and the essence, order, sequence or the like of the component are not limited by the terms. When it is mentioned that one component is “connected,” “coupled,” or “accessed” to another component, it may be understood that the one component is directly connected, coupled or accessed to another component or that still other component interposed between the two components is “connected,” “coupled,” or “accessed.”

Components included in one example embodiment and components of another example embodiment having a common function will be described using the same name. Unless otherwise stated, descriptions of one example embodiment may be applied to other embodiments as well, and detailed descriptions within the overlapping range will be omitted.

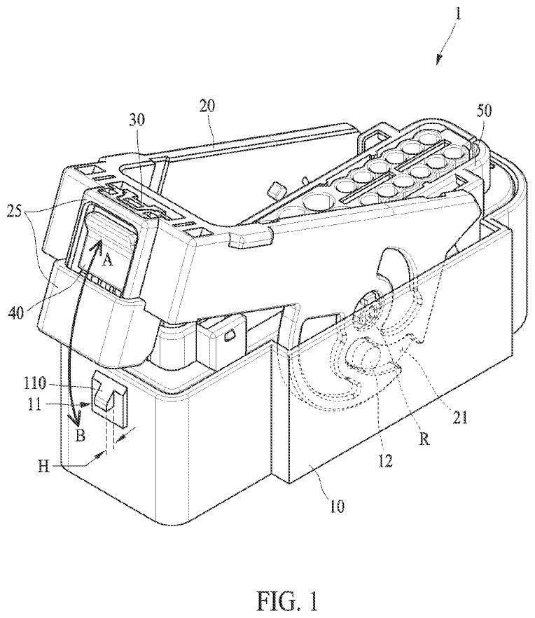

Referring to FIG. 1, the connector assembly 1 according to an example embodiment may physically and electrically connect two different electronic devices. The connector assembly 1 includes two connectors coupled to each other. The connector assembly 1 includes a base connector 10, a body connector 50, a main lever 20, a locking lever 30, and a position assurance slider 40.

The base connector 10 includes a plurality of base connector terminals (not shown). The base connector 10 has a plurality of holes for accommodating the plurality of terminals. The base connector 10 includes a locking protrusion 11 formed on an outer circumferential surface. The base connector 10 includes a base connector protrusion 12 formed to protrude from the inside. The base connector protrusion 12 has a shape protruding inward from the inner surface of the base connector 10.

The body connector 50 may be connected to the base connector 10. The body connector 50 is inserted into the base connector 10. The body connector 50 includes a plurality of body connector terminals (not shown). The body connector 50 includes a plurality of holes for accommodating a plurality of terminals. The body connector 50 rotatably supports the main lever 20. The body connector 50 includes a rotation protrusion R connected to the main lever 20. The rotation protrusion R has a shape protruding outward from the outer surface of the body connector 50. The body connector 50 is slidable in a single degree of freedom along the base connector 10. For example, the external shape of the body connector 50 corresponds to the internal shape of the base connector 10.

The main lever 20 is rotatably connected to the body connector 50. The main lever 20 may be rotationally moved in a direction (B) to be bound with the base connector 10 or a direction (A) to be released from the base connector 10 around the rotation protrusion (R) of the body connector 50. The main lever 20 includes a locking lever 30 and a housing 25 capable of accommodating the position assurance slider 40 disposed outside the locking lever 30.

The housing 25 may be integral with the main lever 20 and formed on one end of the main lever 20. Since the housing 25 may be integral with the main lever 20, when the main lever 20 is rotationally moved, the housing 25 is rotationally moved together with the main lever 20. While the main lever 20 is bound to the base connector 10, the housing 25 protects the locking protrusion 11, the locking lever 30 is bound to the locking protrusion 11, and the position assurance slider 40 from the outside. The housing 25 includes a housing opening for controlling the position assurance slider 40. The housing opening may be opened to expose a part of the position assurance slider 40 to the outside.

The base connector protrusion 12 is formed to protrude from the inside of the base connector 10 may be engaged with the rotation groove 21 of the main lever 20. Therefore, when the main lever 20 is rotated in the direction B to be bound to the base connector 10, the base connector protrusion 12 formed to protrude from the inside of the base connector 10 is slid along the rotation groove 21 of the main lever 20, and the connector disposed inside the base connector 10 and the main lever 20 may be firmly connected to each other.

The locking lever 30 is formed on the main lever 20, and may be locked with and bound to the locking protrusion 11 formed on the outer circumferential surface of the base connector 10. When the main lever 20 is rotated in the direction B to be bound to the base connector 10, the locking lever 30 on the main lever 20 slides along a locking protrusion inclined surface 110 of the locking protrusion 11, and then is locked and fixed by passing through the locking protrusion inclined surface 110.

The locking protrusion 11 of the base connector 10 may be formed to have a locking width H of 1.5 mm or more. Specifically, in the case of the connector assembly 1 according to an example embodiment of the present disclosure, when the main lever 20 is rotated, a gap due to the assembly tolerance between the rotation protrusion R of the body connector and the main lever 20 occurs. The gap generated due to the rotation structure acts as an element that inhibits the solid bond between the locking protrusion 11 and the locking lever 30. At this time, when the locking width H of the locking protrusion 11 is formed to a sufficient height, it is possible to prevent the bond between the locking protrusion 11 and the locking lever 30 from being released due to the gap. Therefore, considering the gap that may occur in the rotation protrusion R, the locking protrusion 11 of the connector assembly 1 according to an example embodiment may have a higher width than a general connector assembly, and the corresponding width may be designed to be 1.5 mm or more, preferably 1.7 mm or more.

The position assurance slider 40 is disposed to surround the outside of the locking lever 30, and structurally engaged to slide with the locking lever 30. When the main lever 20 is rotated in the direction (B) in which the main lever 20 is bound to the base connector 10 so that the locking lever 30 is locked with the locking protrusion 11, the position assurance slider 40 prevents the locking lever 30 from being separated from the locking state by an external impact.

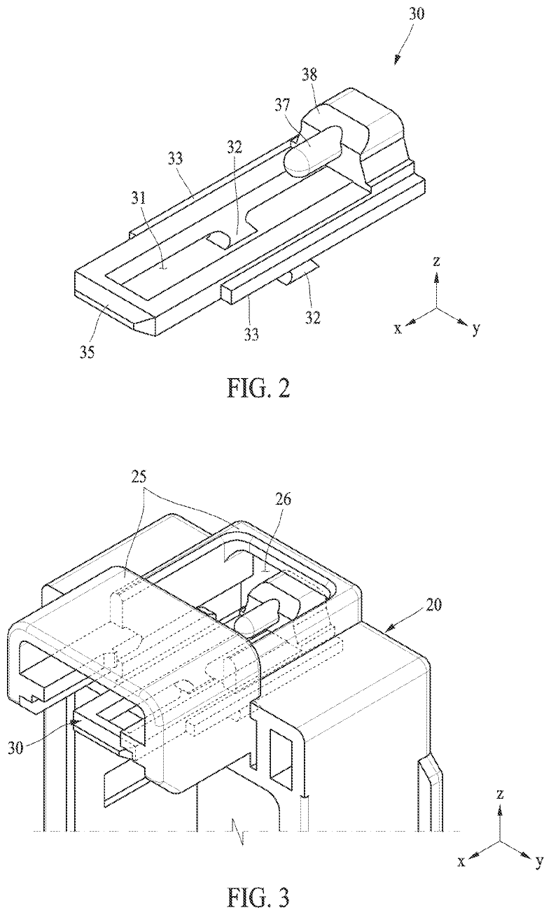

Referring to FIG. 2, the locking lever 30 includes a bridge 32 integrally connected with the main lever, a locking lever opening 31 capable of accommodating a part of the position assurance slider or the locking protrusion of the base connector, a locking lever rib 33 capable of engaging with the position assurance slider so as to slide with the position assurance slider, and a locking lever edge 35 capable of sliding along the locking protrusion of the base connector.

The bridge 32 structurally connects the locking lever 30 and the main lever. When the main lever is rotated, since the locking lever edge 35 of the locking lever slides along the locking protrusion inclined surface of the locking protrusion, the bridge 32 may be elastically deformed within a limited range so that the locking lever 30 can move along the locking protrusion inclined surface.

The locking lever opening 31 may accommodate the locking protrusion or a portion of the position assurance slider according to the rotation state of the main lever. When the locking lever 30 is locked with the locking protrusion as the main lever is rotated in the direction to be bound to the base connector, the locking protrusion may be accommodated in the locking lever opening 31. On the other hand, when the main lever is rotated in the direction in which the main lever is released from the base connector and the locking lever 30 and the locking protrusion are released, a part of the position assurance slider (e.g., an arm to be described later) is accommodated in the locking lever opening 31.

The locking lever rib 33 engages a part of the position assurance slider so that the position assurance slider may slide relative to the locking lever. The position assurance slider engaged with the locking lever 30 due to the locking lever rib 33 slides with respect to the locking lever in a predetermined direction (e.g., the x-axis direction).

An elastic member capable of pressing the position assurance slider is disposed between the locking lever 30 and the position assurance slider, and the locking lever 30 includes a cylinder 37 on which the elastic member is mounted. The elastic member may be, for example, a spring, that presses the position assurance slider in the first direction (e.g., +x direction) in which the length of the elastic member increases. The position assurance slider may be moved in the first direction by the elastic member and locked with the locking lever edge 35 of the locking lever. Separation of the locking lever 30 locked with the locking protrusion is prevented by fixing the locking lever 30.

In addition, the locking lever 30 includes a main inclined surface 38 connected to the cylinder 37. When the main lever is released from the locking protrusion, the position assurance slider locked with the locking lever edge 35 may be pressed and slid in the second direction (e.g., −x direction) that compresses the elastic member such that the bond between the position assurance slider and the locking lever 30 is released. The second direction is a direction opposite to the first direction. In this case, the main inclined surface 28 is formed in a shape in which the position assurance slider may slide smoothly in the second direction. This will be described in detail with reference to FIG. 9 below. In other words, the position assurance slider may be formed to be inclined in accordance with the direction in which pressure is applied to release the position assurance slider from the locking lever.

FIG. 3 illustrates an arrangement state of the main lever 20, the locking lever 30, and the housing 25 of the connector assembly according to an example embodiment.

Here, the locking lever 30 is disposed on the main lever 20 and is connected to the main lever 20 through the aforementioned bridge. The main lever 20 includes a housing 25 capable of accommodating the locking lever 30. The housing 25 of the main lever 20 accommodates a position assurance slider, which will be described later. The housing 25 may include a housing opening 26 that is open to control the position assurance slider disposed on the outside of the locking lever 30.

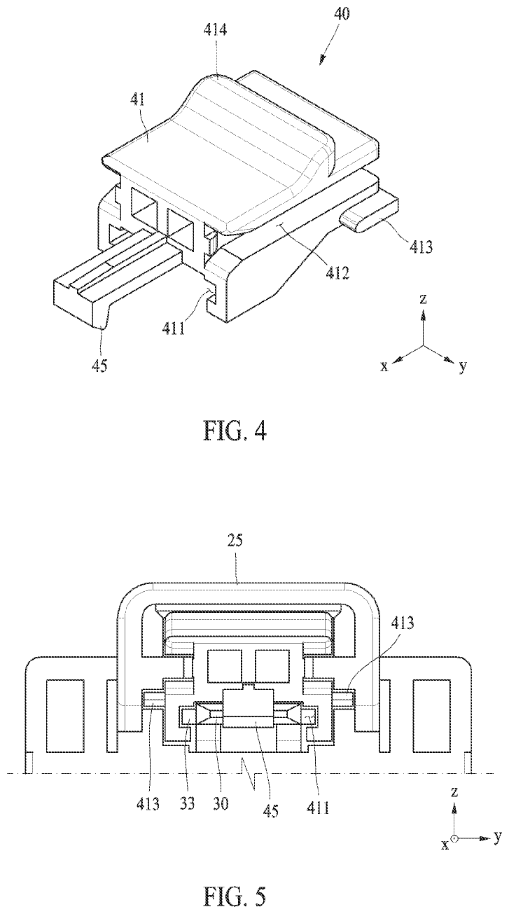

FIG. 4 is a perspective view illustrating a position assurance slider 40 of a connector assembly according to an example embodiment.

Referring to FIG. 4, the position assurance slider 40 includes a slider body 41 connected to the locking lever, a first slider body groove 411 formed on the slider body 41 and slidably engaged with the locking lever, a second slider body groove 412 formed on the slider body 41 and capable of engaging with the housing, a guide protrusion 413 formed on the slider body 41 and capable of guiding the movement of the position assurance slider, an arm 45 extending from one end of the slider body 41 and capable of preventing separation of the locking lever, and a pressure handle 414 formed to apply pressure to the position assurance slider in the second direction to release engagement with the locking lever.

The first slider body groove 411 accommodates the locking lever rib of the above-described locking lever, so that the position assurance slider 40 may be slidably engaged with the locking lever. The arm 45 may prevent separation of the locking lever locked with the locking protrusion by overlapping with the locking lever edge of the locking lever and being locked with the locking lever edge.

The first slider body groove 411 and the locking lever rib may be in a state in which the first slider body groove 411 and the locking lever rib are always engaged regardless of the rotation state of the main lever. On the other hand, the second slider body groove 412 and the housing may be in a state of being engaged or released depending on the case.

The guide protrusion 413 is formed to protrude from the side surface of the slider body 41 and guide the movement of the position assurance slider by being accommodated in a guide groove of a housing to be described later.

The pressure handle 414 is formed to include a curved surface in a predetermined shape so as to apply pressure to the position assurance slider in the second direction in order to release the bond between the position assurance slider 40 and the locking lever.

FIG. 5 is a diagram illustrating an arrangement state of the housing 25, the locking lever, and the position assurance slider of the connector assembly according to an example embodiment.

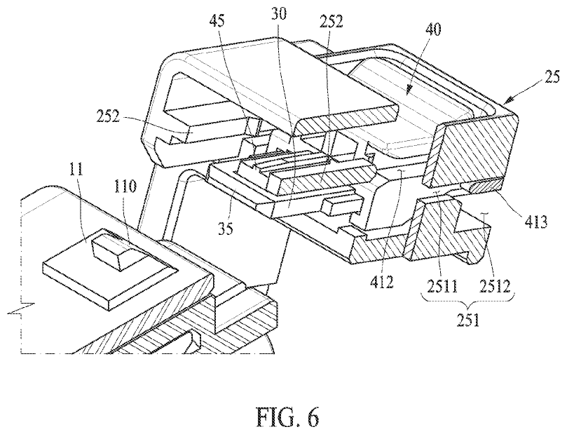

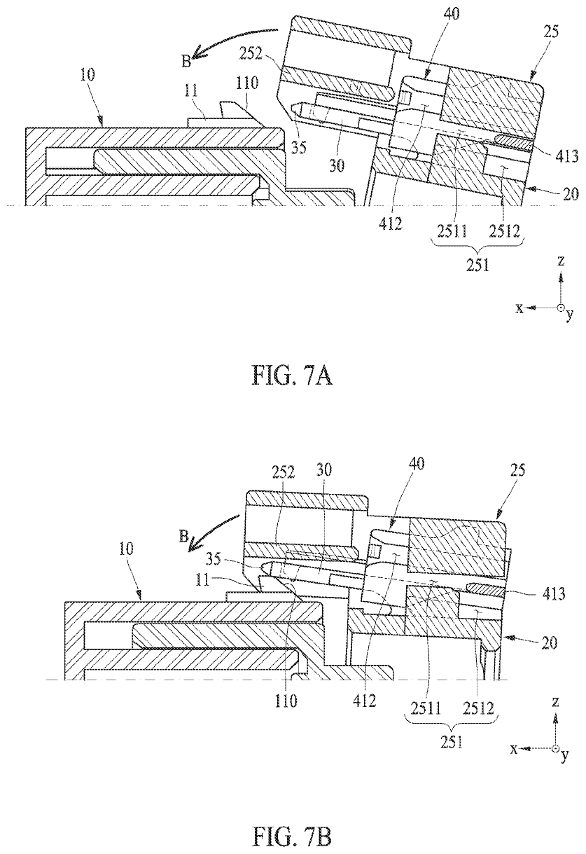

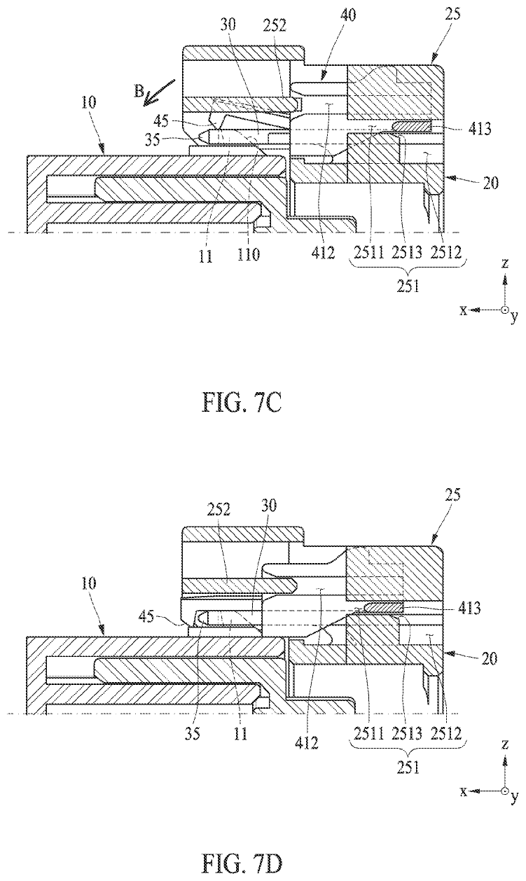

Referring to FIG. 5, the locking lever and the position assurance slider are accommodated inside the housing 25 in an engagement state. The locking lever rib 33 of the locking lever 30 may be accommodated inside the first slider body groove 411 of the position assurance slider to be engaged. The guide protrusion 413 of the position assurance slider engages the housing 25, and the housing 25 includes a guide groove for accommodating and guiding the guide protrusion 413. The engagement state of the guide protrusion and the guide groove will be described in detail with reference to FIG. 6 to FIG. 7D, which will be described later.

The arm 45 of the position assurance slider may be locked while overlapping the edge of the locking lever of the locking lever. The arm 45 in the locking state with the locking lever edge may prevent the locking lever from being separated from the locking protrusion of the base connector.

FIG. 6 illustrates the inside of the housing 25 of the connector assembly according to an example embodiment.

Referring to FIG. 6, in a state in which the locking lever 30 and the locking protrusion 11 are released, the arm 45 of the position assurance slider is accommodated in the locking lever opening of the locking lever 30. When the main lever is rotated in the direction in which the locking lever moves toward the locking protrusion, the locking lever edge 35 of the locking lever slides and moves along the locking protrusion inclined surface 110 of the locking protrusion 11. After that, when the locking lever edge 35 is in the locking state with the locking protrusion 11, the arm 45 of the position assurance slider 40 is pressed and moved by the elastic member, and prevents separation of the locking lever by being locked with and overlapping the locking lever edge 35 of the locking lever.

The housing 25 includes a guide groove 251 for accommodating and guiding the guide protrusion 413 of the position assurance slider 40. The guide groove 251 includes a first guide 2511 capable of moving the accommodated guide protrusion in a predetermined direction (e.g., the first direction and the second direction) and a second guide 2512 connected with one end of the first guide and having a width wider than a width of the first guide.

In the case of the first guide 2511, the movement direction of the guide protrusion is controlled by limiting the space in which the guide protrusion 413 can move to a predetermined range. In other words, when the guide protrusion 413 of the position assurance slider 40 is accommodated in the first guide 2511 of the housing 25, the position assurance slider 40 and the housing 25 may be in a state of being engaged with each other.

On the other hand, when the guide protrusion 413 of the position assurance slider 40 is accommodated in the second guide 2512, the guide protrusion 413 moves in a direction toward the first guide 2511 (e.g., the first direction), and also moves in a direction toward the free space in the second guide. In other words, in a state in which the guide protrusion 413 is accommodated in the second guide 2512, the position assurance slider 40 may only be engaged with the locking lever, and the housing 25 is not engaged. In other words, in this case, the position assurance slider 40 may not be structurally bound to the housing 25. Accordingly, when the position assurance slider 40 is pressed through the housing opening, the guide protrusion 413 also moves toward the free space in the second guide 2512, and at this time, the locking lever structurally engaged with the position assurance slider 40 also moves together in the same direction.

The housing 25 includes a housing rib 252 that is engageable by being accommodating in the aforementioned second slider body groove 412 of the position assurance slider 40. The housing rib 252 is accommodated in the second slider body groove 412 of the position assurance slider 40 in a first state in which the guide protrusion 413 of the position assurance slider 40 is accommodated in the first guide 2511 of the housing 25. In other words, in a second state in which the guide protrusion 413 of the position assurance slider 40 is accommodated in the second guide 2512 of the housing 25, the housing rib 252 is spaced apart from the second slider body groove 412 of the position assurance slider 40, and thus the housing 25 may not engage the position assurance slider 40.

FIG. 7A to FIG. 7D are diagrams illustrating a securing process of a locking lever and a position assurance slider of a connector assembly according to an example embodiment.

First, referring to FIG. 7A, when the main lever 20 is rotated in the direction B to be secured to the base connector 10, the locking lever edge 35 of the locking lever 30 may move toward the locking projection 11 formed to protrude on the base connector 10. When the locking protrusion inclined surface 110 of the locking protrusion 11 and the locking lever edge 35 of the locking lever do not contact, the guide protrusion 413 of the position assurance slider 40 may be in the second state in which the guide protrusion 413 is accommodated in the second guide 2512 of the guide groove 251 of the housing 25. Accordingly, the position assurance slider 40 is engaged with the locking lever while not engaged with the housing 25. In this case, the housing rib 252 of the housing 25 may not be accommodated in the second slider body groove 412 of the position assurance slider 40 and may be spaced apart from the second slider body groove 412 of the position assurance slider 40.

Referring to FIG. 7B, when the main lever 20 rotates in the direction (B) to be bound to the base connector 10 so that the locking lever edge 35 of the locking lever 30 contacts the locking protrusion inclined surface 110 of the locking protrusion 11, the locking lever edge 35 slides along the locking protrusion inclined surface 110. At this time, elastic deformation occurs in the bridge 32 of the locking lever, so that the position in the housing of the locking lever and the position assurance slider engaged with the locking lever may be changed. In other words, due to the elastic deformation of the bridge 32, the locking lever 30 is tilted with respect to the main lever 20. In addition, the position assurance slider 40 structurally engaged with the locking lever 30 may also be tilted with respect to the main lever 20 at the same angle as the locking lever. As described above, the locking protrusion 11 of the connector assembly according to an example embodiment of the present disclosure may have a width of 1.5 mm, preferably 1.7 mm or more. At this time, damage applied to the position assurance slider 40 in the process of locking with the locking protrusion 11 (in particular, damage due to stress generated between the slider body and the arm) is reduced, as the position assurance slider 40 is engaged with the locking lever 30 and tilted at the same angle. Accordingly, the occurrence of breakage may be reduced while being repeatedly locked with and bound to the locking protrusion 11 having a high width.

The guide protrusion 413 of the position assurance slider 40 may move within the free space of the second guide 2512 of the housing 25. In other words, in this state, since the guide protrusion 413 and the housing 25 are not in contact with each other, damage of the guide protrusion 413 that may be generated in contact with the housing 25 due to the tilting of the position assurance slider 40 is reduced. Further, the position assurance slider 40 engages with the locking lever 30 and moves together as described above, so that the pressure and impact applied to the position assurance slider 40 is dispersed to the locking lever 30, and as a result, damage of the position assurance slider 40 is reduced.

The second slider body groove 412 of the position assurance slider 40 may be moved toward the housing rib 252 of the housing 25.

Referring to FIG. 7C, when the main lever 20 is rotated by a predetermined distance in the direction B to be bound to the base connector 10, the locking lever edge 35 passes through the locking protrusion and the locking lever 30 and the locking protrusion 11 are in the locking state. At this time, the locking protrusion 11 is accommodated in the locking lever opening of the locking lever, and the arm 45 of the position assurance slider 40 slides along the locking protrusion inclined surface 110 of the locking protrusion 11 due to the pressure of the elastic member. The guide protrusion 413 of the position assurance slider 40 moves from the second guide 2512 of the housing 25 toward the first guide 2511. The guide groove 251 includes a guide groove inclined surface 2513 formed between the first guide and the second guide so that the guide protrusion 413 slides smoothly in this process.

The second slider body groove 412 of the position assurance slider 40 may be moved in a direction to accommodate the housing rib 252 of the housing 25, and one end of the housing rib 252 is in a state accommodated in the second slider body groove 412 of the position assurance slider 40.

Referring to FIG. 7D, due to the pressing of the elastic member against the position assurance slider 40, the arm 45 of the position assurance slider 40 is in the locking state with the locking lever edge 35 by passing through the locking protrusion 11 and then overlapping the locking lever edge 35 of the locking lever 30. The arm 45 in this state prevents the locking lever in the locking state with the locking protrusion 11 from being separated.

The structure of the housing rib 252 accommodated in the second slider body groove 412 and the guide protrusion 413 accommodated in the first guide 2511 prevents the position assurance slider from being lifted by an external shock, shaking or the like by binding the position assurance slider to the housing.

The guide protrusion 413 of the position assurance slider 40 may be in the first state accommodated in the first guide 2511 of the housing 25, and the housing rib 252 of the housing 25 are accommodated in the second slider body groove 412 of the position assurance slider 40. Accordingly, in this first state, the housing 25 and the position assurance slider 40 are engaged with each other.

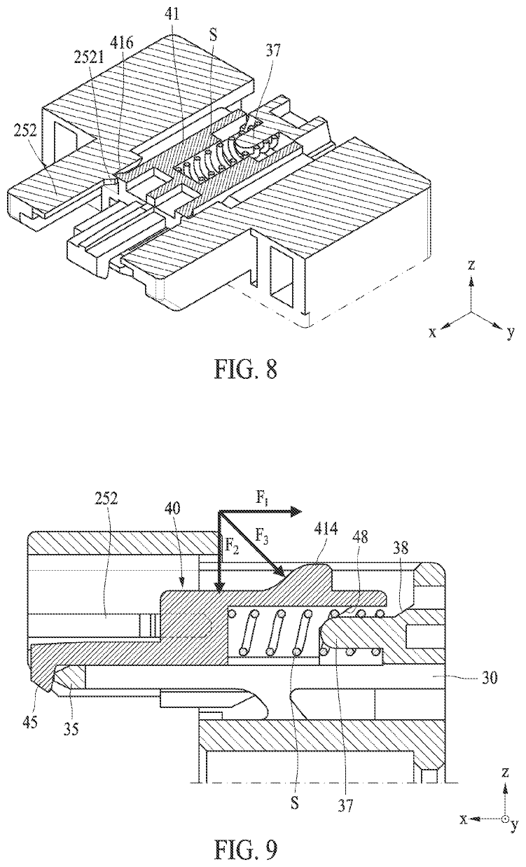

Referring to FIG. 8, the housing rib 252 may include a stopper 2521 capable of restricting movement of the position assurance slider, and the slider body 41 of the position assurance slider may include a slider body protrusion 416 that can be contact with the stopper 2521 of the housing rib. The elastic member S mounted to the cylinder 37 of the locking lever continuously pressures the position assurance slider in the first direction (e.g., the +x direction) in which the length of the elastic member is increased. In this case, the stopper 2521 formed to protrude from the housing rib 252 limits movement of the position assurance slider in the first direction by abutting against the slider body protrusion 416 protruding from the slider body 41.

Referring to FIG. 9, when the position assurance slider 40 is released with the locking lever 30, a pressure F1 applied in a direction opposite to the first direction (e.g., the +x direction) in which the elastic member S mounted on the cylinder 37 presses the position assurance slider 40. In addition, in order to release the arm 45 in the locking state with the the locking lever edge of the locking lever, a pressure F2 in applied the direction of releasing the arm. In this case, the position assurance slider 40 and the locking lever 30 are released by applying a pressure F3 in the direction in which the resultant force of the pressures in the two directions is directed. When the pressure F3 in the direction in which the resultant force is directed is applied to the pressure handle 414 of the position assurance slider 40, the position assurance slider 40 may be released from the locking lever 30 by sliding along the main inclined surface 38 formed at a predetermined angle. On the position assurance slider 40, a slider inclined surface 48 having the same angle as the main inclined surface 38 is formed so as to be slid in contact with the main inclined surface 38 of the locking lever 30. The slider inclined surface 48 may be slid in contact with the main inclined surface 38 when the position assurance slider 40 is under a force in the direction F3 in which the resultant force of the two directions is directed.

As described above, an example embodiment has been described with reference to specific matters such as specific components and limited example embodiments and drawings, but these are provided to help the overall understanding. In addition, the present disclosure is not limited to the above-described example embodiments, and various changes and modifications are possible from these descriptions by those skilled in the art to which the present disclosure pertains. Therefore, the spirit of the present disclosure should not be limited to the above-described embodiments, and not only the claims to be described later, but also all those with equivalent or equivalent modifications to the claims are within the scope of the spirit of the present disclosure.

What is claimed is:

1. A connector assembly comprising:
a base connector having a locking protrusion formed on an outer circumferential surface;
a body connector being insertable into the base connector;
a main lever configured to be rotatably coupled to the body connector;
a locking lever formed on the main lever and being engageable with the locking protrusion; and
a position assurance slider disposed to engage with the locking lever to be slidable with respect to the locking lever and preventing separation of the locking lever engaged with the locking protrusion.

2. The connector assembly of the claim 1, further comprising an elastic member disposed between the position assurance slider and the locking lever, and capable of pressing the position assurance slider,
wherein the position assurance slider is slidable with respect to the locking lever in a first direction pressed by the elastic member in a second direction opposite to the first direction.

3. The connector assembly of claim 2, wherein the main lever comprises a housing for accommodating the locking lever and the position assurance slider, and
the housing selectively contacting with the position assurance slider.

4. The connector assembly of claim 3, wherein the housing comprises a guide groove guiding movement of the position assurance slider in a predetermined direction in a first state in which the housing is in contact with the position assurance slider, or guiding the position assurance slider to move within a predetermined range in a second state in which the housing does not contact with the position assurance slider.

5. The connector assembly of claim 4, wherein the position assurance slider comprises:
a slider body configured to engage with the locking lever;
an arm extending from one end of the slider body and preventing separation of the locking lever; and
a guide protrusion formed to protrude from both sides of the slider body and guiding movement of the position assurance slider by being accommodated in the guide groove.

6. The connector assembly of claim 4, wherein the guide groove comprises a first guide configured to move the position assurance slider in a predetermined direction, and a second guide connected to one end of the first guide and having a wider width than the first guide.

7. The connector assembly of claim 4, wherein the position assurance slider engages with the housing in the first state, and
the position assurance slider is released with the housing in the second state.

8. The connector assembly of claim 4, wherein the position assurance slider comprises a second slider body groove configured to engage with the housing in the first state, and
the housing comprises a housing rib capable of being accommodated in the second slider body groove.

9. The connector assembly of claim 8, wherein the housing rib comprises a stopper limiting a range of movement of the position assurance slider.

10. The connector assembly of claim 1, wherein the locking lever comprises a locking lever opening for accommodating the locking protrusion or engaging with the position assurance slider.

11. The connector assembly of claim 1, wherein the locking lever comprises a locking lever rib configured to engage the position assurance slider, and
the position assurance slider comprises a first slider body groove accommodating the locking lever rib.

12. The connector assembly of claim 4, wherein the locking lever comprises a main inclined surface formed so that the position assurance slider is slidable from the first state to the second state.
